(19) United States
(12) Patent Application Publication
(10) Pub. No.: US 2007/0092782 A1
(43) Pub. Date: Apr. 26, 2007

(54) Multiple flowfield circuits to increase fuel cell dynamic range

(76) Inventor: Robert L. Fuss, Spencerport, NY (US)

Correspondence Address: CARY W. BROOKS;General Motors Corporation, Legal Staff, Mail Code 482-C23-B21, P.O. Box 300, Detroit, MI, 48265-3000, US

(21) Appl. No.: 11/258,489

(22) Filed: Oct. 25, 2005

(51) Int. Cl. H01M 8/02; H01M 8/24

(52) U.S. Cl. 429/38; 429/39; 429/13

(57) ABSTRACT

A method and device for operating a fuel cell system. The device includes a flowfield plate that includes a header section and a channel section. The header section includes inlet flowpaths and outlet flowpaths, where the inlets formed in the header section are fluidly decoupled from one another, as are the outlets. The channel section is divided into multiple circuits, each dedicated to a corresponding inlet and outlet. The circuits may be of different flow capacities, and may be operated independently of one another, making the device particularly adapted to both full and part-power operation.

### BACKGROUND OF THE INVENTION

The present invention relates generally to operating a fuel cell system, and more particularly to staging the flow of fuel cell reactants during various operating power levels.

In a typical fuel cell configuration, an electrolyte is sandwiched between electrodes (specifically, an anode and a cathode) such that positive ions generated at the anode flow through the electrolyte and react with ions generated at the cathode, while current generated by the flow of free electrons produced at the anode during the oxidation of the anode reactant (for example, hydrogen) and consumed at the cathode during the reduction of the cathode reactant (for example, oxygen) can be used to power one or more external devices. In one type of fuel cell, called a proton exchange membrane (PEM) fuel cell, the electrolyte makes up part of a core called a membrane electrode assembly (MEA). The MEA includes a hydrated ion exchange membrane and two gas diffusion layers disposed between electrically-conducting cathode and anode flowfield plates, where one of the diffusion layers is between the first catalyst and the anode flowfield plate and the other is between the second catalyst and the cathode flowfield plate. Continuous channels in the plates allow for the reactants to pass over the corresponding diffusion layer, catalyst and electrode, where an electrochemically active catalyst (such as platinum) is typically disposed between each face of the membrane and the respective diffusion layers. Cooling channels may also be employed to keep temperature buildup to a minimum; these cooling channels may be formed in the anode or cathode flowfield plates (for example, on the opposite side of the plate from the respective anode or cathode circuit), or may define their own flowfield plate.

By stacking individual fuel cells relative to one another, more powerful systems can be built, where each individual fuel cell is electrically connected (typically in series to increase overall stack voltage). In a stack configuration, both faces of the flowfield plates can be used (in what is termed a bipolar plate), where one side of a plate promotes the anode reaction, while the opposite side of the plate promotes the cathode reaction. An example of a single plate being used as both an anode and cathode collector can be found in U.S. Pat. No. 6,503,653, owned by the assignee of the present invention and herein incorporated by reference. In such a fuel cell stack, common fluid delivery conduit can be used to efficiently bring the reactants (as well as coolant or hydrating fluid) to each plate via header (also referred to as a manifold) that is formed by the aligned stacking of apertures within each plate.

Reactants and reaction products are transported to and from the fuel cell membrane assembly through the channels formed in the flowfield plates. These passages typically extend from an inlet header to an outlet header through a path configured to maximize contact area and consequent reaction within each cell. The channels are often overdesigned, in that they are sized to provide adequate flow capability for the system's full-power setting. Thus, even in low-power situations, the fluid continues to traverse all of the channels, causing a reduction in fluid velocity and a concomitant reduction in the motive force used to remove excess water that builds up at the cathode as a result of the fuel-oxygen reaction. In these conditions of inadequate fluid throughflow, which is particularly acute at low power settings, the water can become trapped within the channel and diffusion layer, impeding subsequent flow and causing portions of the cell to stop producing electricity, resulting in unstable system performance.

Prior approaches to stabilizing the fuel cell at low power settings have focused on utilizing multiple stacks with extensive valving and control systems. Such approaches add complexity, weight, volume and cost to the system. Accordingly, there exists a need for an improved fuel cell system that can be operated at various power levels without reductions in system performance or durability or increases in system complexity. There also exists a need for improvements in fuel cell systems operating at various power levels such that the dynamic range of stable operation is enhanced.

### BRIEF SUMMARY OF THE INVENTION

These needs are met by the present invention, wherein a fuel cell system and a method of operating the system in such a way as to avoid the operational instabilities of the prior art is disclosed. In accordance with a first aspect of the present invention, a device including a flowfield plate is disclosed. The flowfield plate includes a header section and a channel section. The header section includes an inlet region and an outlet region, where within each region, a plurality of flowpaths are defined that are fluidly decoupled from one another. The channel section has numerous circuits, each configured to convey a fluid across a portion of the flowfield plate's surface. In the present context, the term “fluid” includes compounds, mixtures, elements or the like in either their gaseous or liquid state. By way of example, the inlet region is divided such that a first inlet flowpath is exclusively fluidly coupled to a first circuit, while a second inlet flowpath is exclusively fluidly coupled to a second circuit, and a third inlet flowpath is exclusively fluidly coupled to a third circuit. The outlet region can be similarly divided. In the present context, a channel is an individual, dedicated path that operates to convey the fluid (such as a reactant used in a fuel cell) between the inlet and outlet flowpaths in a substantially autonomous manner, such that (absent a fluid interconnection between them) there is little or no cross-talk among the various channels during the period the fluid is traversing the path of each channel. In the present context, the term “substantially” is utilized to represent the inherent degree of uncertainty that may be attributed to any quantitative comparison, value, measurement, or other representation. As such, it refers to an arrangement of elements or features that, while in theory would be expected to exhibit exact correspondence or behavior, may in practice embody something slightly less than exact. The term also represents the degree by which a quantitative representation may vary from a stated reference without resulting in a change in the basic function of the subject matter at issue.

Optionally, the numerous circuits are of different flow capacity such that depending on the power requirements of the fuel cell, one or more of the circuits can be used simultaneously. In a preferred embodiment, the channel section has at least three circuits. In such configuration, a first of the circuits has a flow capacity of up to approximately sixty percent of the flow capacity of the channel section, while second and third the circuits has a flow capacity of up to approximately twenty five and fifteen percent, respectively. In a more particular form, smaller secondary circuits have fewer channels than a primary, or main, circuit. This helps make the smaller circuits more responsive to operational transients and part-power (i.e., low power) operating conditions. The channels making up the circuits may define a change of direction angle that is small relative to traditional serpentine layouts with angular and hairpin (i.e., U-shaped) bends that involve a reversal of flow direction, thereby reducing the impact of pressure drops within the channels. For example, bend angles in individual flow channels in excess of ninety degrees will out of necessity involve at least some component of flow reversal, where U-shaped bends amount to a one hundred and eighty degree change in direction, amounting to a complete reversal of flow. In other configurations, the channels may exhibit significant (or even complete) flow reversal. The device may further include a coupling section to fluidly connect the header and channel sections. The coupling section may be made up of numerous manifolds, each capable of feeding fluid to and receiving fluid from numerous flow channels. Each of the flowpaths is made up of an aperture formed into the header section; this allows each aperture to be in fluid communication with the coupling section. The flowfield plate can be used to transport reactant fluid, cooling fluid or both for a fuel cell. Accordingly, in one form, the flowfield plate can be a cathode flowfield plate. In one embodiment, the coolant flowpaths are fluidly decoupled from the cathode flowpaths to provide for some measure of cooling, while in another embodiment they could be directly coupled to the flowpath to provide additional cooling in the active areas. Multiple circuits can be utilized on one or all of the anode, cathode and cooling layers, and in various combinations to achieve better environmental conditions (including temperature, humidity and reactant concentrations) for the reactions. These can motivated by both performance and durability considerations.

In another option, an MEA can be disposed between anode and cathode flowfield plates. The MEA is made up of an ion exchange membrane with an anode side and a cathode side, a diffusion layer in fluid communication with each membrane side, and a catalyst cooperative with the diffusion layer and the ion exchange membrane. In this way, when reactants (such as hydrogen and oxygen) are introduced to the respective anode and cathode sides of the ion exchange membrane, an electrochemical reaction occurs, producing electricity. Additionally, the device may include one or more valves placed in fluid communication with one or both of the cathode flowfield header sections. The valve can be used to preferentially route at least a portion of the second reactant to at least one of the first and second circuits. A controller can be incorporated to regulate the opening and closing of the one or more valves, while a sensor can also be included to detect conditions upon which the controller will open or close the valve. A control mechanism can be configured to affect distribution of fluid between the various circuits as a function of a power demand. For example, when the power level is low, the reactant or coolant may be routed through one or more of the smaller circuits, while when the power level is high, the larger circuit can be used, possibly in conjunction with one or more of the smaller circuits.

The device may further include a power conversion mechanism configured to take the electricity generated by the electrochemical reaction and convert it to motive power, where the motive power can be used to propel a vehicular platform. The vehicular platform (an example of which can be a car, truck, motorcycle, rail craft, aircraft or watercraft) may house the power-production device and the power conversion mechanism. In one form, the vehicular platform may include a passenger compartment, wheels, a directional control mechanism (such as a steering wheel) cooperative with the wheels, and a braking mechanism configured to retard the effects of the propulsive force on the platform.

According to yet another aspect of the invention, a fuel cell stack includes a plurality of fuel cells. Each of the cells in the stack includes an anode flowfield plate, a cathode flowfield plate and an MEA, the last made up of an anode, cathode and membrane. The plurality of flowpaths include a first flowpath and a second flowpath fluidly decoupled from one another, and a control mechanism to affect distribution of fluid between the first and second flowpaths as a function of a power demand on the fuel cell. Thus, during a first power demand level placed on the fuel cell stack, the first flowpath conveys a portion of the second reactant, while during a second power demand level placed on the fuel cell stack, at least the second flowpath conveys a portion of the second reactant. In this mode of operation, the second power demand level is considered greater than the first power demand level. Thus, during a low power setting, the smaller first flowpath can be used to transport reactant, and may (although not necessarily) remain on during higher power settings. By contrast, the second larger flowpath does not permit flow of the reactant until a minimum need threshold (determined by, for example, a fuel cell power setting) is met. In addition, the control mechanism can be used to control the actuation of one or more valves, where a control signal can come from one or more sensors in signal communication with the controller, or from manual input.

In one optional embodiment, the cathode flowfield plate includes three circuits, while in another, the anode flowfield plate includes at least two circuits. An additional option includes a plurality of cooling channels placed in a heat exchange relationship with at least one of the cathode or anode flowfield plates. These cooling channels can be formed on a separate plate, or may be formed on one side of the cathode or anode flowfield plate. In another embodiment, the cooling channels may be interspersed on the same side of the same plate as the anode or cathode channels.

According to still another aspect of the invention, a method of operating a fuel cell system is disclosed. The method includes introducing a first reactant and second reactant to the fuel cell, and distributing at least one of the reactants within a flowfield plate as a function of fuel cell power. As previously described, the system may include an anode flowfield plate, a cathode flowfield plate and an MEA. Optionally, the method includes preferentially routing most or all of an oxygen-bearing reactant to one or more of the smaller circuits at least during part-power operating conditions of the system, for example, when the fuel cell power falls below a predetermined threshold. In the present context, part-power operating conditions are those associated with low power operation, where the fuel cell power output is below (preferably well below) its rated capacity. The system may also include a control mechanism to affect distribution of fluid between the various channels as a function of fuel cell power, and may include one or more valves, as well as be responsive to signals from one or more sensors. This way, upon receipt of a signal from the sensor, the controller can manipulate the valve to achieve fluid routing commensurate with the fuel cell operating conditions. As before, the smaller circuit (or circuits) is characterized by a lower flow capacity than the primary (main) circuit. In one form, the channel section comprises three circuits, the first with about sixty percent of the overall channel flow capacity, the second with about twenty five percent and the third about fifteen percent. It will of course be appreciated by those skilled in the art that other ratios between the circuits may be employed, and that such ratios are within the scope of the present invention.

### BRIEF DESCRIPTION OF THE SEVERAL VIEWS OF THE DRAWINGS

The following detailed description of the present invention can be best understood when read in conjunction with the following drawings, where like structure is indicated with like reference numerals and in which:

FIG. 1 shows a block diagram of a fuel cell system configured for vehicular application;

FIG. 2 shows a cutaway view of a PEM fuel cell;

FIG. 3A shows an obverse side of a cathode flowfield plate incorporating multiple circuits therein, as well as a divided header section for separating fluid flow into and out of those circuits;

FIG. 3B shows a reverse side of the flowfield plate of FIG. 3A, highlighting cooling channels;

FIG. 3C shows a detail of one of the individual flow channels of the flowfield plate of FIG. 3B, highlighting the bifurcation;

FIG. 4 shows a fuel cell stack with conduit for reactant delivery to and removal from the stack;

FIG. 5 shows an exploded view of a fuel cell stack with conduit for reactant delivery to and removal from the stack;

FIG. 6 shows a vehicle employing the fuel cell system of the present invention; and

FIG. 7 shows an obverse side of an alternate embodiment of the cathode flowfield plate.

### DETAILED DESCRIPTION OF THE PREFERRED EMBODIMENTS

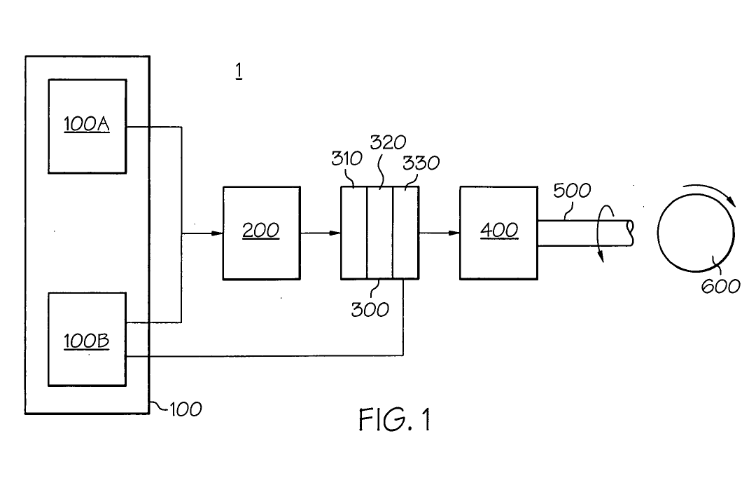

Referring initially to FIG. 1, a block diagram highlights the major components of one configuration of a mobile fuel cell system 1. The system includes a fuel delivery system 100 (made up of fuel source 100A and oxygen source 100B), fuel processing system 200, fuel cell 300, one or more energy storage devices 400, a drivetrain 500 and one or more motive devices 600, shown notionally as a wheel. While the present system 1 is shown for mobile (such as vehicular) applications, it will be appreciated by those skilled in the art that the use of the fuel cell 300 and its ancillary equipment is equally applicable to stationary applications, such as for electric power generators. It will also be appreciated by those skilled in the art that other fuel delivery and fuel processing systems are available. For example, there could be, in addition to a fuel source 100A and oxygen source 100B, a water source (not shown). Likewise, in some variants where substantially purified fuel is already available, the fuel processing system 200 may not be required. The energy storage devices 400 can be in the form of one or more batteries, capacitors, electricity converters, or even a motor to convert the electric current coming from the fuel cell 300 into mechanical power such as rotating shaft power that can be used to operate drivetrain 500 and one or more motive devices 600. The fuel processing system 200 may be incorporated to convert a raw fuel, such as methanol into hydrogen or hydrogen-rich fuel for use in fuel cell 300; otherwise, in configurations where the fuel source 100A is already supplying substantially pure hydrogen, the fuel processing system 200 may not be required. Although only a single fuel cell 300 is shown, it will be appreciated by those skilled in the art that fuel cell system 1 (especially those for vehicular and related applications) may be made from a stack of such cells serially connected. Thus, while the term “fuel cell” is generally indicative of a single fuel cell within a larger stack of such cells, it may also be used to define the entire stack. Such usage will be clear, based on the context.

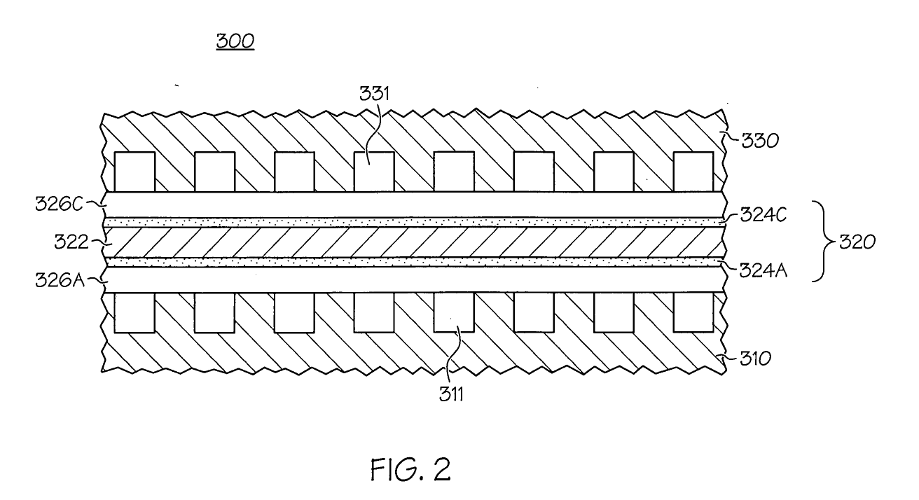

Referring next to FIG. 2, one cell 300 of a fuel cell stack includes an anode flowfield plate 310, cathode flowfield plate 330, and MEA 320 disposed between anode flowfield plate 310 and cathode flowfield plate 330. Channels 311 carry fluid (such a first reactant, typically a fuel such as gaseous hydrogen) to enable the fluid to contact the respective diffusion layer 326A and catalyst 324A (the latter typically in the form of finely-divided particles of a noble metal, such as platinum) of the anode side of the MEA 320. Similarly, channels 331 carry fluid (such as a second reactant, typically an oxidant such as gaseous oxygen) to enable the fluid to contact the respective diffusion layer 326C and catalyst 324C of the cathode side of the MEA 320. The ion exchange membrane 322 is placed between each of the anode flowfield plate 310 and cathode flowfield plate 330 to allow the ionized fuel produced at the anode side of the MEA 320 to flow through the membrane while inhibiting the passage of electrical current, which instead is routed through the conductive anode and cathode flowfield plates 310, 330 to a load (not shown) such that a motor or related current-responsive device may be operated. Upon introduction of fuel into the anode and oxidant into the cathode and subsequent reaction with the MEA 320, electricity is generated, producing heat, water and water vapor. This water formation is especially prevalent on the cathode flowfield plate 330 of the fuel cell 300, as ionized hydrogen can combine with ionized oxygen to form water droplets.

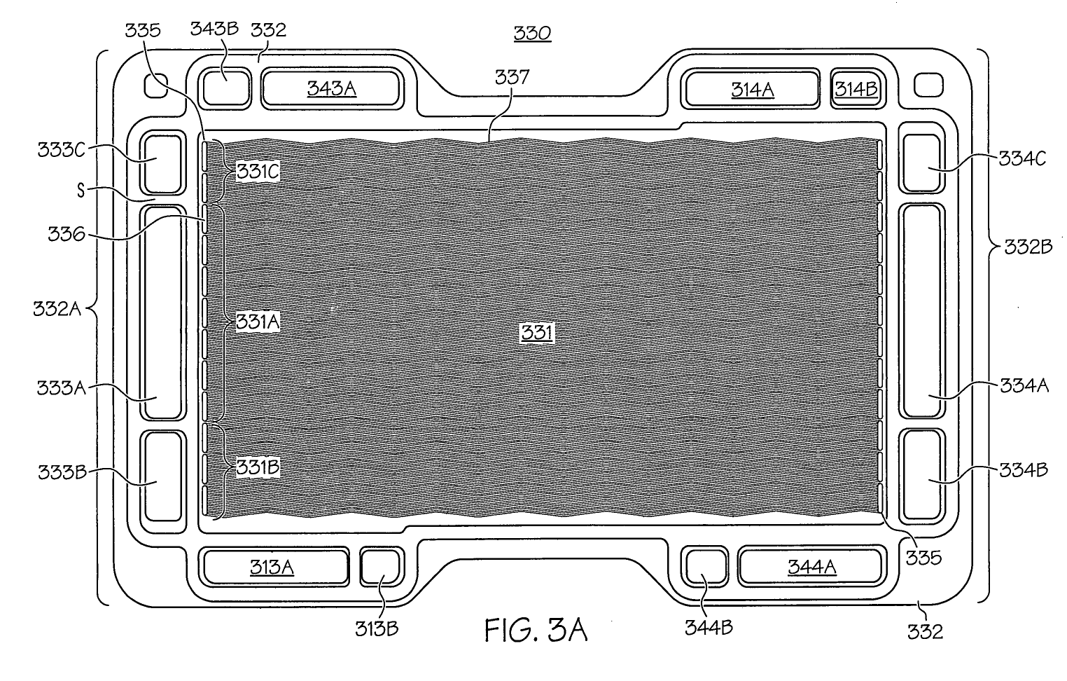

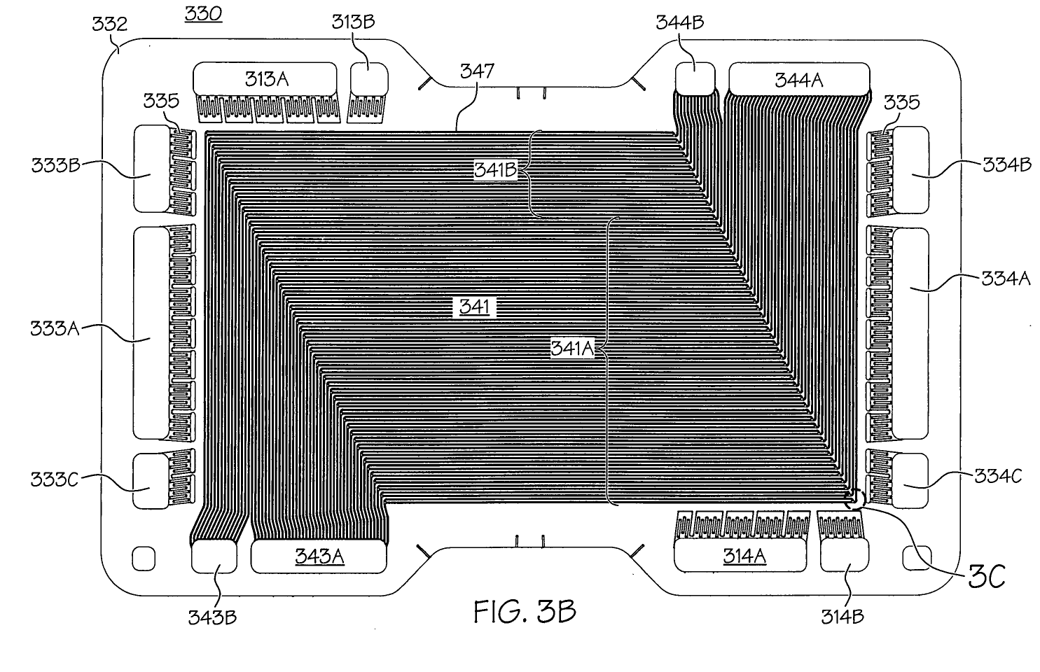

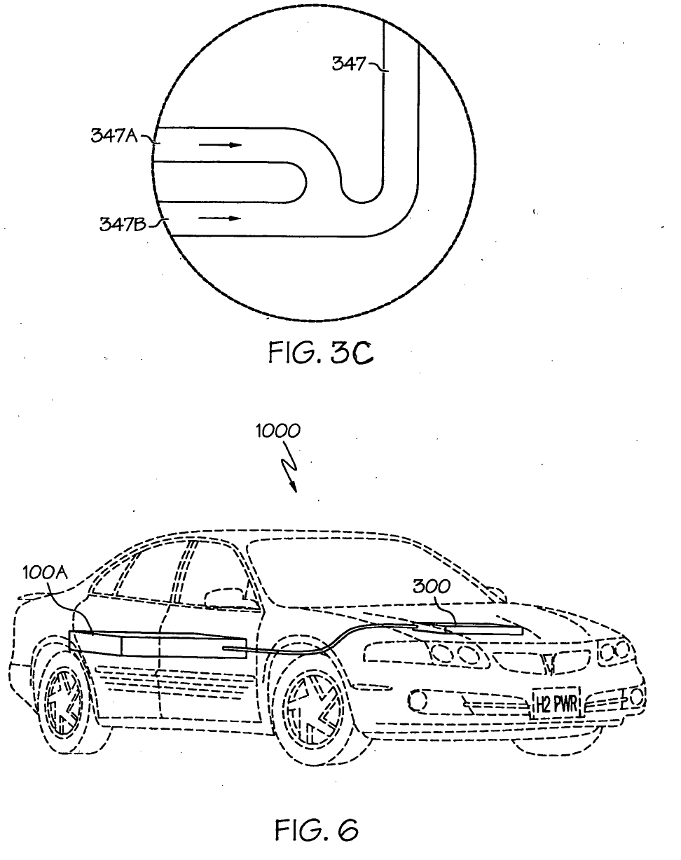

Referring next to FIGS. 3-A through 3C, obverse and reverse sides respectively are shown for a cathode flowfield plate 330 according to an embodiment of the present invention. Plate 330 includes a channel section 331 and a header section 332 disposed around the periphery of the channel section 331. Within the header section 332, numerous passages define flowpaths for anode and cathode reactants, as well as coolant. These flowpaths make up an inlet header 332A and an outlet header 332B. It will be appreciated that within the confines of the cathode flowfield plate 330, although both headers 332A and 332B accommodate both inlet and outlet flows, the designation “inlet” and “outlet” is purely arbitrary, pertaining to the direction of flow of the oxygen-bearing fluid. A similar convention could be adopted to refer to any headers formed on the anode flowfield plate. The inlet header 332A includes inlet flowpaths 333A, 333B and 333C for the flow of reactant, flowpaths 343A and 343B for the flow of coolant and flowpaths 313A and 313B for the flow of anode reactant (the latter of which will be described in more detail below). The inlet header 332A is divided such that a septum S (only one of which is labeled) keeps fluid flowing through the various flowpaths separate from each other.

Referring with particularity to FIG. 3A, channel section 331 is divided up into a first, larger circuit 331A and two smaller circuits 331B, 331C. These circuits are aligned with and connect the inlet flowpaths 333A, 333B and 333C of the inlet header 332A to their respective outlet flowpaths 334A, 334B and 334C of outlet header 332B through numerous individual flow channels 337. The presence of the divided flowpath ensures that fluid flow through the stacked header section 332 remains dedicated to the corresponding circuits within channel section 331. Each of circuits 331A, 331B and 331C include groupings of the individual flow channels 337, where connection of a grouping is effected through a manifold 335. One or more manifolds are in turn grouped into dedicated flow with one of the circuits 331A, 331B and 331C. First circuit 331A defines the majority of the channel flow capacity (about sixty percent, as shown). Second and third circuits 331B, 331C connect the smaller inlet flowpaths 333B, 333C to the respective smaller outlet flowpaths 334B in a manner generally similar to that of the first circuit 331A, capable of transporting approximately twenty five and fifteen percent respectively of flow capacity. Instead of having numerous hairpin (U-shaped) and related serpentine bends, the circuits employ small-angle bends, thereby minimizing pressure loss for fluid flowing through the channels while still providing a long flowpath. It will be appreciated that flowfield plate 330 can be configured to have the cathode flowfield formed on one side, while the cooling flowfield can be formed on the other, as shown with particularity in FIGS. 3B and 3C, or the flowfields can be formed on separate plates.

Referring with particularity to FIGS. 3B and 3C, the distribution of coolant is shown. Channel section 341 is divided up into a first, larger circuit 341A and a smaller circuit 341B. Header section has a pair of inlet flowpaths 343A, 343B fluidly connected to outlet flowpaths 344A, 344B, employing numerous individual flow channels 347, which can form up to a ninety degree bend therein to allow coolant coverage over the substantial entirety of the surface of channel section 341. Each of the individual flow channels 347 is bifurcated at the first ninety degree bend, splitting into parallel branches 347A and 347B. This approach allows the channels to cover the same amount of channel section 341 surface area without having to resort to the U-turn serpentine of prior art designs.

By maintaining separate flowpaths and corresponding circuits (discussed below), the adaptability of flowfield plate 330 to varying fluid flow levels, such fluid flow levels often commensurate with power levels generated by the fuel cell 300, is enhanced. For example, under low power operating conditions, it may not be desirable to keep all of the flow channels 337 of channel section 331 open for fluid passage, as under such low power conditions, the spreading of the driving force and amount of flow across the substantial entirety of the channels may not provide enough motive force within each channel to remove water that forms within the channels. Such a situation could, if not resolved, lead to a gradual buildup of water droplets, which could in turn lead to unstable operation (especially at lower power settings) and possible shutdown of one or more channels, leading to a loss in power output.

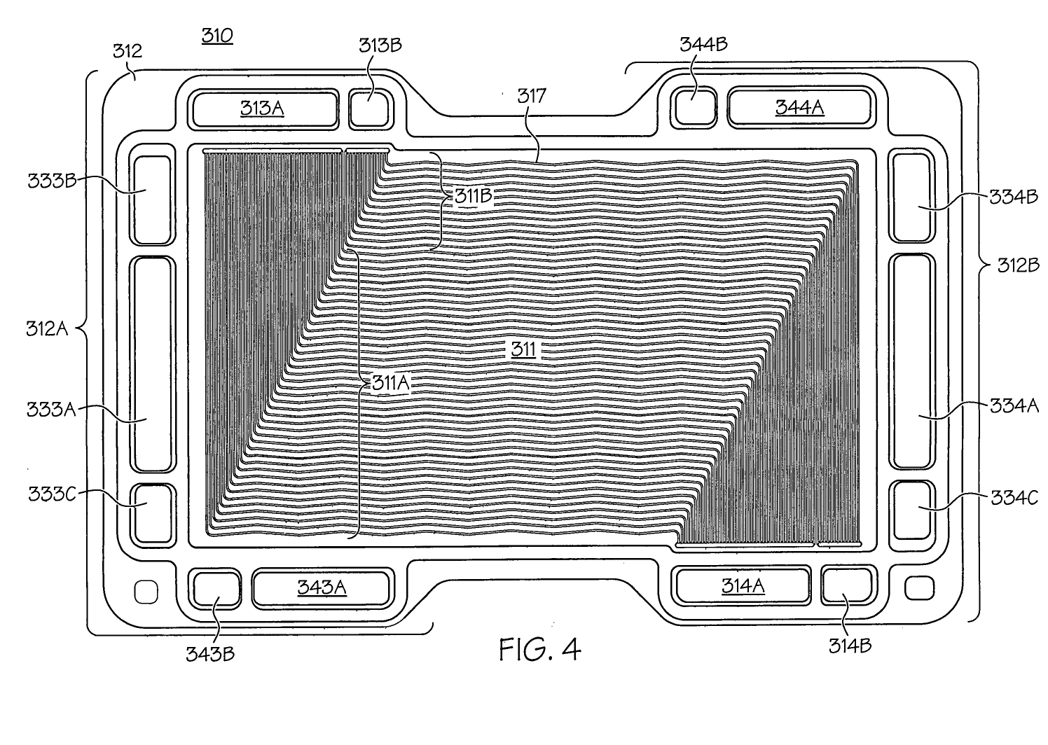

Referring next to FIG. 4, details of the anode flowfield plate 310 include many of the same features of the cathode flowfield plate 330, including attributes of both the obverse side (for reactant) and the reverse side (for coolant). Channel section 311 is surrounded by header section 312, which is made up of an inlet header 312A and an outlet header 312B. Channel section 311 is made up of circuits 311A and 311B, where individual flow channels 317 make up the circuits. As before, the various inlet flowpaths 313A, 313B, 331A, 331B, 331C, 343A and 343B are defined by apertures formed through the surface of the header section 312 so that upon aligned stacking of numerous plates, a built-up conduit is formed through which reactant or coolant can be conveyed.

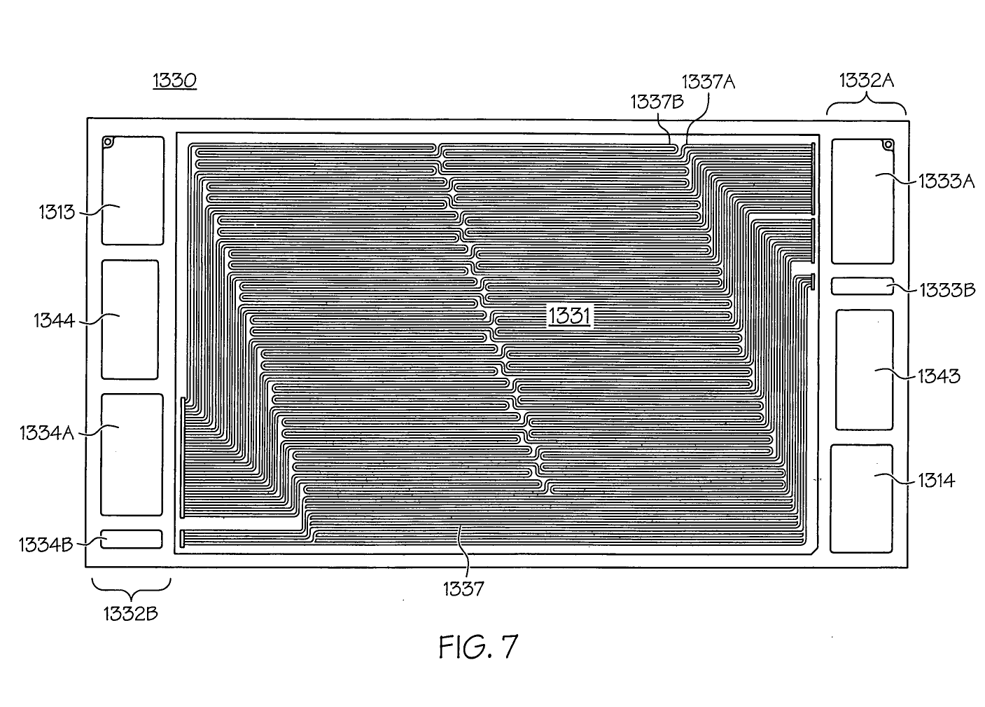

Referring next to FIG. 7, an obverse side shown of an alternate embodiment cathode flowfield plate 1330 is shown. Whereas the embodiment depicted in FIGS. 3A, 3B and 4 included divided flow circuits amongst each of the anode, coolant and cathode circuits (with the last having a three-way split), the cathode flowfield plate 1330 includes a single coolant circuit with inlet flowpath 1343 and outlet flowpath 1344, as well as single anode circuit with inlet flowpath 1313 and outlet flowpath 1314, and a dual cathode circuit with divided flowpaths. The first of the divided cathode flowpaths extends from inlet flowpath 1333A to outlet flowpath 1334A, while the second extends from inlet flowpath 1333B to outlet flowpath 1334B. As can be seen from the figure, there are more individual flow channels 1337 making up the first of the divided cathode flowpaths than there are making up the second. In a preferred mode of operation, the smaller second cathode flowpath is used for low power conditions. For example, where a fuel cell stack 3000 is used for a vehicular or related mobile applications and the vehicle is not consuming significant amounts of power (such as at an idle condition), the flow of reactant fluid to the cathode 330 can be limited to the second circuit. Also unlike the embodiment depicted in FIGS. 3A, 3B and 4, the present embodiment does include bends in the individual flow channels 1337 that can involve significant changes in flow direction. For example, in addition to the ninety degree bends 1337A (which are similar to the bends shown in FIGS. 3B, 3C and 4), the present embodiment also includes U-shaped bends 1337B.

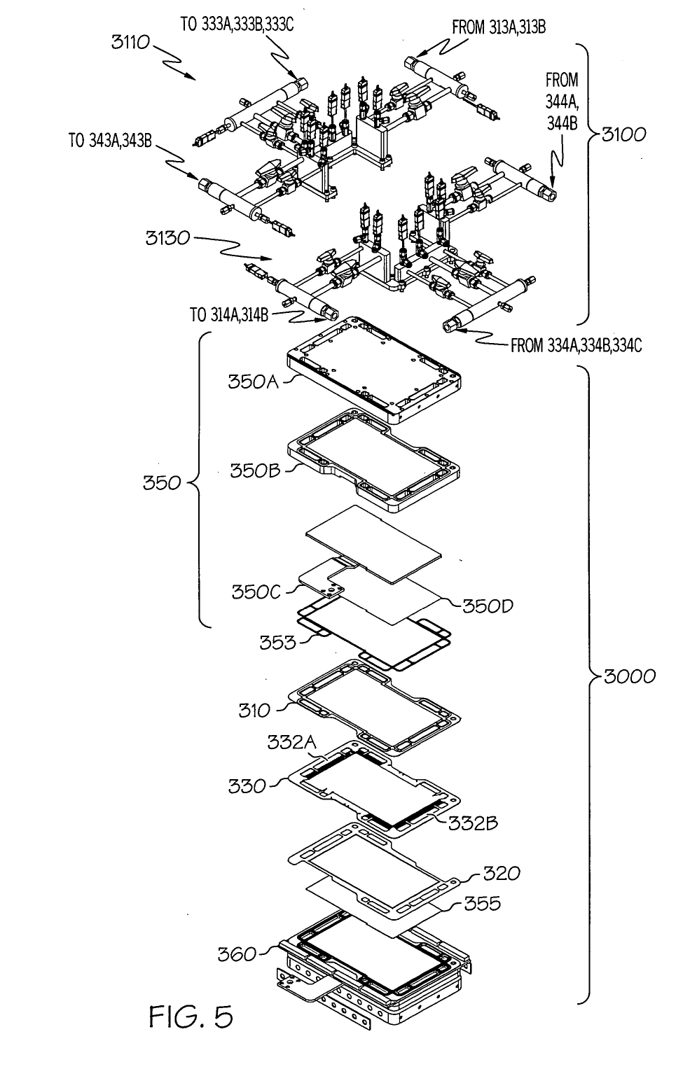

Referring next to FIG. 5, a fuel cell stack 3000 made up of numerous individual fuel cells 300 that are fed by fluid conduits 3100 is shown. Stack 3000 includes numerous plates or layers aligned together in a generally laminated fashion, terminating in end plates 350 and 360. End plate 350 includes subcomponents, including a wet end baseplate 350A, wet end insulator 350B and wet end terminal 350C, which includes a diffusion media 350D. Seal 353 is placed between the end plate 350 and anode flowfield plate 310. Cathode flowfield plate 330, with inlet header 332A and outlet header 332B, can be placed adjacent the anode flowfield plate 310. Although not shown, it will be appreciated by those skilled in the art that the anode and cathode flowfield plates 310, 330 could be formed on opposing sides of the same plate in a bipolar fashion. Electrolyte layer 320 and another seal 355 are also included.

Fluid conduits 3100 are used to transport the reactants and coolant to and from the stack 3000. A first conduit 3110 (which has one or more valves or related flow-regulating devices disposed therein) can be fluidly coupled to inlet header 332A. This header feeds an oxygen-bearing reactant to inlet flowpaths 333A, 333B and 333C and coolant to the coolant inlet flowpaths 343A, 343B, while receiving a hydrogen-bearing fluid leaving the anode flowpaths 313A, 313B. A second conduit 3130 can be fluidly coupled to outlet header 332B. This header can be used to remove the products of the electrochemical reaction reactant from the outlet flowpaths 334A, 334B and 334C, as well as remove the coolant from coolant outlet 344A, 344B that has passed through the stack 3000. Similarly, second conduit 3130 can be used to supply the hydrogen-bearing reactant to inlet flowpaths 314A and 314B of the outlet header 332B.

Referring lastly to FIG. 6, a vehicle incorporating a fuel cell system according to the present invention is shown. Fuel cell 300 is fluidly coupled to a fuel supply 100A. While the vehicle is shown notionally as a car, it will be appreciated by those skilled in the art that the use of fuel cell systems in other vehicular forms is also within the scope of the present invention.

While certain representative embodiments and details have been shown for purposes of illustrating the invention, it will be apparent to those skilled in the art that various changes may be made without departing from the scope of the invention, which is defined in the appended claims.

What is claimed is:

1. A fuel cell comprising an anode, a cathode electrically coupled to said anode, a membrane disposed between said anode and said cathode, and at least one flowfield plate, said flowfield plate comprising:
a header section comprising an inlet region and an outlet region, at least one of said regions comprising a plurality of flowpaths fluidly decoupled from one another; and
a channel section comprising a plurality of circuits therein, each of said circuits configured to convey a fluid placed therein from at least one of said flowpaths in said inlet region to a corresponding flowpath in said outlet region such that any one circuit remains substantially fluidly decoupled from the remainder of said plurality of circuits at least in said channel section.

2. The fuel cell of claim 1, wherein each of said circuits comprise a plurality of flow channels therein, each of said flow channels configured to operate substantially fluidly independent from one another.

3. The fuel cell of claim 2, further comprising a coupling section configured to establish fluid communication between said header section and said channel section.

4. The fuel cell of claim 3, wherein said coupling section comprises a plurality of manifolds, each fluidly coupled to a plurality of flow channels.

5. The fuel cell of claim 4, wherein each of said flowpaths define an aperture formed in said header section such that each said aperture is in fluid communication with said coupling section.

6. The fuel cell of claim 1, wherein at least one of said circuits has a different flow capacity than the remainder of said circuits.

7. The fuel cell of claim 6, wherein said channel section comprises at least three said circuits.

8. The fuel cell of claim 7, wherein a first of said circuits has a flow capacity of up to approximately sixty percent of the flow capacity of said channel section.

9. The fuel cell of claim 8, wherein a second of said circuits has a flow capacity of up to approximately twenty five percent of the flow capacity of said channel section, while a third of said circuits has a flow capacity of up to approximately fifteen percent of the flow capacity of said channel section.

10. The fuel cell of claim 1, wherein said plurality of flowpaths comprises a plurality of cathode flowpaths configured to convey an oxygen-bearing reactant therethrough.

11. The fuel cell of claim 10, wherein bend angles of individual flow channels within said channel section do not exceed ninety degrees.

12. The fuel cell of claim 10, wherein said plurality of flowpaths further comprise at least one coolant flowpath placed in thermal communication with said cathode flowpaths.

13. The fuel cell of claim 12, wherein said plurality of flowpaths further comprise at least one anode flowpath configured to convey at least one hydrogen-bearing reactant therethrough.

14. The fuel cell of claim 1, further comprising at least one valve in fluid communication with said header section to preferentially route at least a portion of a fluid flowing therethrough to at least one of said plurality of circuits.

15. The fuel cell of claim 14, further comprising a controller cooperative with at least one valve to regulate the opening and closing thereof, said controller configured to affect distribution of fluid between said plurality of circuits as a function of a power demand on said fuel cell.

16. A vehicle comprising the fuel cell of claim 1, wherein said fuel cell serves as a source of motive power for said vehicle.

17. A fuel cell stack assembly comprising:
a plurality of fuel cells electrically coupled to one another, each of said fuel cells comprising an anode configured to accept a first reactant therein, a cathode configured to accept a second reactant therein, a membrane disposed between said anode and cathode, said membrane configured to allow an ionized portion of said first reactant to pass therethrough on its way from said anode to said cathode, an anode flowfield plate configured to transport said first reactant adjacent said anode such that said first reactant ionizes thereon, and a cathode flowfield plate configured to transport said first reactant adjacent said cathode such that said second reactant can react with portions of said first reactant that pass through said membrane, said cathode flowfield plate comprising a plurality of flowpaths, said plurality of flowpaths comprising:
a first flowpath; and
a second flowpath fluidly decoupled from said first flowpath; and
a control mechanism configured to affect distribution of fluid between said first and second flowpaths as a function of a power demand on said fuel cell such that during a first power demand level placed on said fuel cell stack, said first flowpath conveys a portion of said second reactant, while during a second power demand level placed on said fuel cell stack, at least said second flowpath conveys a portion of said second reactant, said second power demand level being greater than said first power demand level.

18. A method of operating a fuel cell system, said method comprising:
configuring said system to include:
an anode flowfield plate;
a cathode flowfield plate comprising:
a header section comprising an inlet region and an outlet region, at least one of said regions comprising a plurality of flowpaths fluidly decoupled from one another; and
a channel section comprising a plurality of circuits therein, each of said circuits configured to convey a reactant placed therein from at least one of said flowpaths in said inlet region to a corresponding flowpath in said outlet region such that any one circuit remains substantially fluidly decoupled from the remainder of said plurality of circuits at least in said channel section; and
a membrane electrode assembly disposed between said anode and cathode flowfield plates;
introducing a first reactant to said membrane electrode assembly;
introducing a second reactant to said membrane electrode assembly through said inlet region; and
distributing said second reactant in said channel section as a function of a power level in said fuel cell system.

19. The method of claim 18, wherein at least one of said circuits has a different flow capacity than the remainder of said circuits.

20. The method of claim 19, wherein said distributing comprises routing a substantial entirety of said second reactant to a lower flow capacity circuit of said plurality of circuits when said power level falls below a predetermined threshold.

21. The method of claim 20, wherein said predetermined threshold is up to fifteen percent of said system's full-power operating capability.

22. The method of claim 19, wherein said configuring said system further comprises coupling a control mechanism to said cathode flowfield plate to affect distribution of reactant through said channel section as a function of a power demand on said fuel cell.

23. The method of claim 22, wherein said control mechanism comprises:
at least one valve in fluid communication with said inlet region;
a controller cooperative with said at least one valve; and
a sensor in signal communication with said controller such that upon receipt of a signal from said sensor, said controller can manipulate said at least one valve.
